(19) United States
(12) Patent Application Publication
(10) Pub. No.: US 2021/0317751 A1
(43) Pub. Date: Oct. 14, 2021

(54) FAN CONTAINMENT CASING

(71) Applicant: Rolls-Royce plc, London (GB)

(72) Inventors: Kevin Mee, London (GB); David Groves, London (GB)

(21) Appl. No.: 17/260,046

(22) PCT Filed: Jul. 12, 2019
(86) PCT No.: PCT/EP2019/068850

§ 371 Date: Jan. 13, 2021

(30) Foreign Application Priority Data
Jul. 13, 2018 (GB) 1811543.6

(51) Int. Cl. F01D 21/04; F01D 25/24; F02K 3/06

(52) U.S. Cl. CPC F01D 21/045; B32B 27/12; F02K 3/06; F01D 25/24

(57) ABSTRACT

A structural support casing for fan blade containment in a gas turbine engine includes at least one region in which two or more sub-laminates of fibre-reinforced composite material are spaced apart from one another by ductile polymeric material.

### CROSS-REFERENCE TO RELATED APPLICATIONS

This application is a U.S. National Stage Application under 35 U.S.C. § 371 of International Application No. PCT/EP2019/068850, filed Jul. 12, 2019, which claims the benefit of priority to United Kingdom Application No. GB 1811543.6, filed on Jul. 13, 2018, and the present application claims the benefit of the filing date of both of these prior applications, which are incorporated by reference in their entireties.

### FIELD

The present disclosure concerns structural support casings for fan blade containment in gas turbine engines.

### BACKGROUND

Gas turbine engines include a fan having fan blades in front of the engine. The fan may be contained in a hardwall fan containment case. During operation, any one of the fans blades may break off from the fan and impact the hardwall fan containment case. This is generally referred to as a fan blade-off (FBO) event. After a turbine engine fan loses a blade, the loads on the fan containment case rise well above those experienced in normal flight conditions because of the fan imbalance. During engine shut down, which is typically about a few seconds, cracks can propagate rapidly in the hardwall fan containment case from the damage caused by the impact of the FBO, which may lead to containment failure.

Hardwall fan containment cases are typically made of titanium and are designed to stop a broken blade. More recently, hardwall fan containment cases made of fibre-reinforced composite materials have been proposed. Composite fan containment cases are strong and typically lighter than cases made of titanium, but can be susceptible to brittle fracture on impact of a broken fan blade.

### SUMMARY OF INVENTION

According to a first aspect, there is provided a structural support casing for fan blade containment in a gas turbine engine, the structural support casing comprising at least one region in which two or more sub-laminates of fibre-reinforced composite material are spaced apart from one another by ductile polymeric material.

The structural support casing may be a fan containment casing (e.g. a fan containment case). The structural support casing may be a hardwall fan containment casing (e.g. a hardwall fan containment case). The structural support casing may be a barrel of a hardwall fan containment casing.

The ductile polymeric material may be more ductile (i.e. less brittle) than the fibre-reinforced composite material.

The elongation to failure of the ductile polymeric material may be greater than the elongation to failure of the fibre-reinforced composite material. It may be that the elongation to failure of the ductile polymeric material is at least about five times, for example, at least about ten times, or at least about fifteen times, or at least about twenty times, or at least about twenty-five times, or at least about thirty times, or at least about thirty-fives times, or at least about forty times, the elongation to failure of the fibre-reinforced composite material. It may be that the elongation to failure of the fibre-reinforced composite material is no greater than about 20%, for example, no greater than about 10%, or no greater than about 5%, or no greater than about 1%, of the elongation to failure of the ductile polymeric material.

It may be that the elongation to failure of the ductile polymeric material is at least about 50%, for example, at least about 75%, or at least about 100%, or at least about 125%, or at least about 150%, or at least about 175%, or at least about 200%. It may be that the elongation to failure of the fibre-reinforced composite material is from about 100% to about 500%. It may be that the elongation to failure of the ductile polymeric material is about 450%. It may be that the elongation to failure of the fibre-reinforced composite material is no greater than about 5%, for example, no greater than about 4%, or no greater than about 3%.

It will be understood that the term “elongation to failure” (otherwise known as “ultimate elongation” or “tensile strain”) is a standard measure of the ductility of a material, i.e. the amount of strain the material can support before failure during tensile testing. The elongation to failure of a material is determined as the strain at which a sample of the material subject to tensile loading fails and is measured in units of percentage strain, for example, according to ASTM D882.

The ductile polymeric material may be less stiff (i.e. more flexible) than the fibre-reinforced composite material.

The tensile modulus of the ductile polymeric material may be lower than the tensile modulus of the fibre-reinforced composite material. It may be that the tensile modulus of the ductile polymeric material is no greater than about 50%, for example, no greater than about 40%, or no greater than about 30%, or no greater than about 25%, or no greater than about 20%, or no greater than about 15%, or no greater than about 10%, of the tensile modulus of the fibre-reinforced composite material. It may be that the tensile modulus of the fibre-reinforced composite material is at least about twice, for example, at least about three times, or at least about four times, or at least about five times, or at least about six times, or at least about seven times, or at least about eight times, or at least about nine times, or at least about ten times, the tensile modulus of the ductile polymeric material.

It may be that the tensile modulus of the ductile polymeric material is no greater than about 15 GPa, for example, no greater than about 10 GPa, or no greater than about 5 GPa, or no greater than about 3 GPa, or no greater than about 2 GPa, or no greater than about 1 GPa. It may be that the tensile modulus of the ductile polymeric material is from about 0.01 GPa to about 2 GPa. It may be that the tensile modulus of the ductile polymeric material is about 0.1 GPa. It may be that the tensile modulus of the fibre-reinforced composite material is no less than about 70 GPa, for example, no less than about 80 GPa, or no less than about 90 GPa, or no less than about 100 GPa, or no less than about 110 GPa, or no less than about 120 GPa.

It will be understood that the term “tensile modulus” refers to the elastic modulus, i.e. Young's modulus, when measured in tension. The tensile modulus for a material is determined as the ratio of stress to strain along the axis of a sample of the material to which a tensile force is applied, measured at relatively low strains such that Hooke's law applies (i.e. in the linear region of a stress-strain plot), for example, according to ASTM D882.

The shear modulus of the ductile polymeric material may be lower than the shear modulus of the fibre-reinforced composite material. It may be that the shear modulus of the ductile polymeric material is no greater than about 50%, for example, no greater than about 40%, or no greater than about 30%, or no greater than about 25%, or no greater than about 20%, or no greater than about 15%, or no greater than about 10%, of the shear modulus of the fibre-reinforced composite material. It may be that the shear modulus of the fibre-reinforced composite material is at least about twice, for example, at least about three times, or at least about four times, or at least about five times, or at least about six times, or at least about seven times, or at least about eight times, or at least about nine times, or at least about ten times, the shear modulus of the ductile polymeric material.

It may be that the shear modulus of the ductile polymeric material is no greater than about 15 GPa, for example, no greater than about 10 GPa, or no greater than about 5 GPa, or no greater than about 3 GPa, or no greater than about 2 GPa, or no greater than about 1 GPa. It may be that the shear modulus of the ductile polymeric material is from about 0.01 GPa to about 2 GPa. It may be that the shear modulus of the ductile polymeric material is about 0.1 GPa.

It will be understood that the term “shear modulus” (otherwise known as the “modulus of rigidity”) refers to the elastic modulus when measured in shear. The shear modulus for a material is determined as the ratio of shear stress to shear strain in a sample of the material to which a shear force is applied, measured at relatively low shear strains in the linear elastic region of a shear stress-strain plot, for example, according to ASTM D882.

The fibre-reinforced composite material may be stronger than the ductile polymeric material. For example, it may be that the tensile strength of the ductile polymeric material is lower than the tensile strength of the fibre-reinforced composite material. Additionally or alternatively, it may be that the yield strength of the ductile polymeric material is lower than the yield strength of the fibre-reinforced composite material.

It may be that the tensile strength of the ductile polymeric material is no greater than about 50%, for example no greater than about 40%, or no greater than about 30%, or no greater than about 20%, or no greater than about 10%, or no greater than about 5%, of the tensile strength of the fibre-reinforced composite material. It may be that the tensile strength of the fibre-reinforced composite material is no less than about twice, for example, no less than about five times, or no less than about ten times, the tensile strength of the ductile polymeric material.

It may be that the tensile strength of the ductile polymeric material is no greater than about 200 MPa, for example, no greater than about 150 MPa, or no greater than about 100 MPa, or no greater than about 50 MPa. The tensile strength of the ductile polymeric material may be, however, no less than about 1 MPa, for example, no less than about 5 MPa, or no less than about 10 MPa. The tensile strength of the ductile polymeric material may be from about 15 MPa to about 150 MPa. The tensile strength of the ductile polymeric material may be about 30 MPa. It may be that the tensile strength of the fibre-reinforced composite material is no less than about 500 MPa, for example, no less than about 750 MPa, or no less than about 1000 MPa, or no less than about 1250 MPa, or no less than about 1500 MPa.

It will be understood that the term “tensile strength” of a material refers to the ultimate tensile strength (UTS) of that material, i.e. the maximum stress experienced by a sample of material when that sample is loaded in tension until failure, for example, according to ASTM D882.

It may be that the yield strength of the ductile polymeric material is no greater than about 50%, for example, no greater than about 40%, or no greater than about 30%, or no greater than about 20%, or no greater than about 10%, or no greater than about 5%, of the yield strength of the fibre-reinforced composite material. It may be that the yield strength of the fibre-reinforced composite material is no less than about twice, for example, no less than about five times, or no less than about ten times, the yield strength of the ductile polymeric material.

It may be that the yield strength of the ductile polymeric material is no greater than about 100 MPa, for example, no greater than about 75 MPa, or no greater than about 50 MPa. However, the yield strength of the ductile polymeric material may be at least about 0.5 MPa, for example, at least about 1 MPa. It may be that the yield strength of the fibre-reinforced composite material is no less than about 500 MPa, for example, or no less than about 750 MPa, or no less than about 1000 MPa.

It will be understood that the term “yield strength”, also referred to as “yield stress”, is the stress at which material begins to deform plastically under tensile testing, i.e. the stress at and above which deformation is non-elastic and therefore non-recoverable. The yield strength can be identified by the stress at which the relationship between stress and strain (on a stress-strain plot) becomes non-linear, for example, according to ASTM D882.

Brittle materials, when tested under tensile loads, may fail with little or no plastic deformation such that the yield strength of the material is essentially equivalent to the ultimate tensile strength of the material. Fibre-reinforced composite materials may be more brittle than ductile. Accordingly, it may be that the yield strength of the fibre-reinforced composite material is the same as the tensile strength of the fibre-reinforced composite material. It may be that the yield strength of the ductile polymeric material is no greater than about 50%, for example no greater than about 40%, or no greater than about 30%, or no greater than about 20%, or no greater than about 10%, or no greater than about 5%, of the tensile strength of the fibre-reinforced composite material. It may be that the tensile strength of the fibre-reinforced composite material is no less than about twice, for example, no less than about five times, or no less than about ten times, the yield strength of the ductile polymeric material.

The fibre-reinforced composite material may be tougher than the ductile polymeric material.

The fracture toughness of the ductile polymeric material may be lower than the fracture toughness of the fibre-reinforced composite material. It may be that the fracture toughness of the fibre-reinforced composite material is at least about twice, for example, at least about five times, the fracture toughness of the ductile polymeric material. It may be that the fracture toughness of the ductile polymeric material is no greater than about 50%, for example, no greater than about 25%, of the fracture toughness of the fibre-reinforced composite material. It may be that the ductile polymeric material has a fracture toughness of no greater than about 10 MPa m^{1/2}, for example, no greater than about 5 MPa m^{1/2}. It may be that the ductile polymeric material has a fracture toughness of no less than about 0.1 MPa m^{1/2}, for example, no less than about 0.5 MPa m^{1/2}. It may be that the fibre-reinforced composite material has a fracture toughness of no less than about 10 MPa m^{1/2}, for example, no less than about 20 MPa m^{1/2}.

It will be understood that the term “fracture toughness” refers to the stress intensity factor at which a thin crack in a material begins to grow under mode I crack opening (i.e. under normal tensile stress applied perpendicular to the crack). Fracture toughness can be measured using the Charpy impact test.

The ductile polymeric material may be soft. The fibre-reinforced composite material may be hard. The ductile polymeric material may be softer (i.e. less hard) than the fibre-reinforced composite material. It may be that the ductile polymeric material has a Shore A hardness no greater than about 95, for example, no greater than about 90, according to ASTM D2240. It may be that the ductile polymeric material has a Shore A hardness no less than about 50, for example, no less than about 55, according to ASTM D2240. It may be that the ductile polymeric material has a Shore A hardness of from about 60 to about 90. It may be that the ductile polymeric material has a Shore A hardness of about 80. It may be that the fibre-reinforced composite material has a Barcol hardness of no less than about 50 according to ASTM D 2583.

It will be appreciated that the mechanical properties (including tensile and shear moduli, elongation to failure, tensile strength, yield strength, fracture toughness, and hardness) of fibre-reinforced composite materials may be anisotropic, that is to say, the mechanical properties of fibre-reinforced composite materials may differ when measured along different axes. Mechanical property anisotropy in a fibre-reinforced composite material may arise due to an asymmetric arrangement of reinforcing fibres within the composite material.

A laminate or sub-laminate of fibre-reinforced composite material may comprise a plurality of reinforcing fibre plies arranged (i.e. embedded) in a laminated structure within a matrix material. Mechanical property anisotropy in fibre-reinforced composite material laminates or sub-laminates may arise due to (a) the asymmetry caused by the arrangement of reinforcing fibre plies to form a laminate or sub-laminate structure and/or (b) the asymmetry caused by orientation of reinforcing fibres within individual plies. In particular, within each individual ply, reinforcing fibres may be substantially aligned along a single direction (i.e. “unidirectional” plies) or they may be randomly orientated with respect to one another in the plane of the ply. In addition, within each laminate or sub-laminate, different plies may contain reinforcing fibres aligned along different directions. For example, a laminate or sub-laminate may comprise one or more plies in which reinforcing fibres are aligned along a first direction (referred to as a 0° orientation) and one or more plies in which reinforcing fibres are aligned along a second direction substantially perpendicular to the first direction (referred to as a 90° orientation). Additionally or alternatively, laminates or sub-laminates may comprise plies arranged at, for example, 30°, 45°, and/or 60° orientations. By combining multiple plies having different orientations to form a single laminate or sub-laminate, the in-plane mechanical properties of that laminate or sub-laminate may be rendered effectively isotropic (while out-of-plane mechanical properties perpendicular to the plies, i.e. along the ply stacking direction, may remain different from the in-plane properties).

Unless otherwise stated, throughout this specification and the appended claims, references to tensile and shear moduli, tensile strength, elongation to failure and yield strength of fibre-reinforced composite materials, or of laminates or sub-laminates comprising fibre-reinforced composite materials, are references to said mechanical properties measured in-plane, i.e. in or parallel to the planes in which individual reinforcing fibre plies lie. In contrast, unless otherwise stated, references to fracture toughness and hardness of fibre-reinforced composite materials, or of laminates or sub-laminates comprising fibre-reinforced composite materials, are references to said mechanical properties measured out-of-plane, i.e. perpendicular to the plane of individual plies.

Some fibre-reinforced composite material laminates or sub-laminates have anisotropic in-plane mechanical properties (e.g. unidirectional laminates or sub-laminates in which most or all of the reinforcing fibre plies are aligned along a single reinforcing fibre axis). Accordingly, unless otherwise stated, references to tensile and shear moduli, tensile strength and yield strength of fibre-reinforced composite materials, or of laminates or sub-laminates comprising fibre-reinforced composite materials, are references to the minimum values of said in-plane mechanical properties for the said fibre-reinforced composite materials, or of laminates or sub-laminates comprising fibre-reinforced composite materials, for example, when measured across a range of in-plane orientations (e.g. at 0°, 45° and 90° to a reinforcing fibre axis). Similarly, unless otherwise stated, references to the elongation to failure of fibre-reinforced composite materials, or of laminates or sub-laminates comprising fibre-reinforced composite materials, are references to the maximum value of said in-plane elongation to failure for said fibre-reinforced composite materials, or of laminates or sub-laminates comprising fibre-reinforced composite materials, for example, when measured across a range of in-plane orientations (e.g. at 0°, 45° and 90° to the reinforcing fibre axis).

It may be that the fibre-reinforced composite material is manufactured by curing a matrix material in which reinforcing fibre plies are embedded. It may be that the ductile polymeric material is not susceptible to degradation (i.e. does not degrade) during the curing process.

It may be that curing the matrix material requires heating the matrix material to a curing temperature. It may be that the ductile polymeric material is not susceptible to degradation (i.e. does not degrade) at the curing temperature of the matrix material. It may be that the ductile polymeric material is not susceptible to thermal degradation (i.e. does not degrade) at or below a temperature of 300° C., for example, at or below a temperature of 250° C., or at or below a temperature of 200° C., or at or below a temperature of 180° C.

It may be that the ductile polymeric material is stable (e.g. chemically and/or physically stable) at the curing temperature of the matrix material. It may be that the ductile polymeric material is stable (e.g. chemically and/or physically stable) at or below a temperature of 300° C., for example, at or below a temperature of 250° C., or at or below a temperature of 200° C., or at or below a temperature of 180° C.

The ductile polymeric material may comprise (e.g. consist of) one or more thermoplastic polymers. The ductile polymeric material may be thermoplastic. It may be that the ductile polymeric material has a melting temperature higher than the curing temperature of the matrix material. It may be that the ductile polymeric material has a melting temperature higher than 180° C., for example, higher than 200° C., or higher than 250° C., or higher than 300° C.

It may be that the ductile polymeric material has a glass transition temperature higher than the curing temperature of the matrix material. It may be that the ductile polymeric material has a glass transition temperature higher than 180° C., for example, higher than 200° C., or higher than 250° C., or higher than 300° C.

The ductile polymeric material may comprise (e.g. consist of) one or more thermosetting polymers. The ductile polymeric material may be thermosetting (e.g. a thermoset). It may be that the ductile polymeric material has a degradation temperature higher than the curing temperature of the matrix material. It may be that the ductile polymeric material has a degradation temperature higher than 180° C., for example, higher than 200° C., or higher than 250° C., or higher than 300° C.

It may be that the ductile polymeric material consists of one polymer. It may be that the ductile polymeric material comprises (e.g. consists of) more than one polymer, e.g. a blend of polymers. It may be that the ductile polymeric material comprises (e.g. consists of) one or more copolymers, e.g. one or more block copolymers.

It may be that the ductile polymeric material comprises one or more additives. It may be that the ductile polymeric material comprises one or more stabilisers, e.g. one or more co-stabilisers. For example, it may be that the ductile polymeric material comprises one or more of the following: plasticizers, reinforcing agents, fire retardants, antioxidants, anti-ozonants, acid scavengers, light-stabilisers (e.g. UV-absorbers). It may be that the ductile polymeric material comprises one or more fillers, for example, one or more mineral fillers.

It may be that the ductile polymeric material consists substantially, for example, greater than 90 wt. %, or greater than 95 wt. %, or greater than 99 wt. %, of polymer. It may be that the ductile polymeric material consists entirely of polymer.

It may be that the ductile polymeric material comprises one or more polymers containing urethane (i.e. carbamate) groups. It may be that the ductile polymeric material comprises (e.g. consists of) polyurethane.

Additionally or alternatively, it may be that the ductile polymeric material comprises one or more polymers formed on reaction of phenolic acid (i.e. phenol) or substituted phenolic acid (i.e. substituted phenol) with formaldehyde (i.e. methanal). For example, it may be that the ductile polymeric material comprises (e.g. consists of) phenolic polymer, for example, phenolic resin (otherwise known as phenol formaldehyde resin). It may be that the ductile polymeric material comprises (e.g. consists of) phenolic resin (i.e. phenol formaldehyde resin) in which the formaldehyde to phenol molar ratio is less than 1. It may be that the ductile polymeric material comprises (e.g. consists of) a novolac polymer.

It may be that the ductile polymeric material comprises one or more polymers containing urea (i.e. carbamide) groups. It may be that the ductile polymeric material comprises (e.g. consists of) polyurea.

It may be that the ductile polymeric material comprises one or more toughened polymers such as toughened adhesives. Toughened adhesives may be toughened polyurethane, toughened phenolic resin, toughened acrylonitrile butadiene, or toughened epoxy resins.

Toughened adhesives may be produced by adding diluents, acrylates or plasticizers to the adhesive. Toughened adhesives may be produced by adding a second phase, such as a thermoplastic or rubber particles to the epoxy resin matrix. Toughened adhesives may be produced by adding polyurethane segments to the adhesive polymer matrix.

It may be that the ductile polymeric material comprises a polymer matrix, in which thermoplastic particles, glass microspheres or polymer microspheres are dispersed. The polymer matrix may be a thermosetting polymer matrix, such as an epoxy resin.

The fibre-reinforced composite material may be fibre-reinforced polymer, i.e. the matrix material of the fibre-reinforced composite material may be a polymer. The matrix material of the fibre-reinforced composite material may be a thermosetting polymer (i.e. a thermoset).

The fibre-reinforced composite material may comprise carbon reinforcing fibres. For example, the carbon reinforcing fibres may be polyacrylonitrile (PAN) based carbon fibers, such as HexTow® IM7 fibres. The fibre-reinforced composite material may be carbon fibre reinforced polymer (CFRP). The fibre-reinforced composite material may comprise resin-bonded unidirectional carbon fibre plies.

The fibre-reinforced composite material may comprise aramid (i.e. aromatic polyamide) reinforcing fibres. The fibre-reinforced composite material may comprise para-aramid reinforcing fibres. For example, the fibre-reinforced composite material may comprise reinforcing fibres formed from poly-paraphenylene terephthalamide (Kevlar®) or p-phenylene terephthalamide (Twaron®).

The fibre-reinforced composite material may comprise reinforcing fibres formed from a thermoset liquid-crystalline polyoxazole. For example, the fibre-reinforced composite material may comprise reinforcing fibres formed from poly(p-phenylene-2,6-benzobisoxazole) (Zylon®).

The matrix material may comprise (e.g. consist of) one or more of the following: epoxy (i.e. cured epoxy resin), polyester, vinyl ester, polyamide (e.g. aliphatic or semi-aromatic polyamides, for example, nylon).

It may be that only two sub-laminates of fibre-reinforced composite material are spaced apart from one another by ductile polymeric material. Alternatively, it may be that more than two sub-laminates of fibre-reinforced composite material are spaced apart from one another by ductile polymeric material. It may be that at least three, for example, at least four, or at least five, sub-laminates of fibre-reinforced composite material are spaced apart from one another by ductile polymeric material.

It may be that the two or more sub-laminates of fibre-reinforced composite material are spaced apart from one another by one or more layers of ductile polymeric material.

It may be that each of the two or more sub-laminates of fibre-reinforced composite material is spaced apart from each adjacent sub-laminate of fibre-reinforced composite material by a (for example, only one) layer of ductile polymeric material. It may be that each of the two or more sub-laminates of fibre-reinforced composite material is spaced apart from each adjacent sub-laminate of fibre-reinforced composite material by a (for example, only one) solid layer of ductile polymeric material. It may be that each (e.g. solid) layer of ductile polymeric material is monolithic, that is to say, substantially structurally and/or chemically continuous.

It may be that the ductile polymeric material is not a foam. The ductile polymeric material may not have a cellular (e.g. open-cell or closed-cell) structure, i.e. the ductile polymeric material may be a non-cellular material. It may be that the ductile polymeric material is not fibre-reinforced, i.e. the ductile polymeric material may be unreinforced. It may be that the two or more sub-laminates of fibre-reinforced composite material are spaced apart from one another by one or more solid layers of unreinforced, ductile polymeric material.

It may be that the two or more sub-laminates of fibre-reinforced composite material and one or more layers of ductile polymeric material are arranged (e.g. stacked) alternately (i.e. in a laminar fashion) along a radial direction substantially perpendicular to a longitudinal axis of the structural support casing (i.e. to form a laminate).

It may be that the two or more sub-laminates and the ductile polymeric material are bonded to one another. The two or more sub-laminates and the ductile polymeric material may be bonded to one another by an adhesive. Alternatively, the two or more sub-laminates and the ductile polymeric material may be bonded to one another without use of an adhesive. For example, a bond may be formed between the two or more sub-laminates and the ductile polymeric material on curing a preform during manufacture of the structural support casing.

The structural support casing may enclose one or more fan liners. The structural support casing may be a structural support casing for enclosing one or more fan liners, for example, a structural support casing configured to enclose one or more fan liners. The structural support casing may support one or more fan liners. The structural support casing may be a structural support casing for supporting one or more fan liners, for example, a structural support casing configured to support one or more fan liners. The one or more fan liners may comprise (e.g. be) one or more impact liners. The one or more fan liners may comprise (e.g. be) one or more acoustic liners. The one or more fan liners may be provided inboard of the structural support casing (e.g. mounted to an inboard surface of the structural support casing, which faces the fan blades when in use in a gas turbine engine).

The at least one region, in which two or more sub-laminates of fibre-reinforced composite material are spaced apart from one another by ductile polymeric material, may extend around at least about 10%, for example, at least about 25%, or at least about 50%, of the circumference of the structural support casing. The at least one region, in which two or more sub-laminates of fibre-reinforced composite material are spaced apart from one another by ductile polymeric material, may extend around the majority of, for example, the entire, circumference of the structural support casing. The at least one region, in which two or more sub-laminates of fibre-reinforced composite material are spaced apart from one another by ductile polymeric material, may extend longitudinally along at least about 5%, for example, at least about 10%, or at least about 20%, or at least about 30%, or at least about 40%, or at least about 50%, of the length of the structural support casing. The at least one region, in which two or more sub-laminates of fibre-reinforced composite material are spaced apart from one another by ductile polymeric material, may extend longitudinally along the majority of the length, for example, the entire length, of the structural support casing. The at least one region, in which two or more sub-laminates of fibre-reinforced composite material are spaced apart from one another by ductile polymeric material, may form at least about 1% , for example, at least about 5%, or at least about 10%, or at least about 15%, or at least about 20%, or at least about 25%, or at least about 30%, or at least about 35%, or at least about 40%, or at least about 45%, or at least about 50%, of the radial thickness of the structural support casing (i.e. the radial thickness of the structural support casing proximate the said at least one region). The at least one region, in which two or more sub-laminates of fibre-reinforced composite material are spaced apart from one another by ductile polymeric material, may form the majority, for example, the entirety of the radial thickness of the structural support casing (i.e. the radial thickness of the structural support casing proximate the said at least one region).

The at least one region, in which two or more sub-laminates of fibre-reinforced composite material are spaced apart from one another by ductile polymeric material, may itself be surrounded by fibre-reinforced composite material. The at least one region, in which two or more sub-laminates of fibre-reinforced composite material are spaced apart from one another by ductile polymeric material, may be embedded in a larger region of fibre-reinforced composite material. For example, the majority of the structural support casing may be formed from fibre-reinforced composite material. The majority (e.g. entirety) of the structural support casing may be formed from fibre-reinforced composite material other than in the at least one region in which two or more sub-laminates of fibre-reinforced composite material are spaced apart from one another by ductile polymeric material. The fibre-reinforced composite material present in the at least one region, in which two or more sub-laminates of fibre-reinforced composite material are spaced apart from one another by ductile polymeric material, may be continuous with (i.e. extend continuously into) the fibre-reinforced composite material surrounding the said at least one region. The two or more sub-laminates of fibre-reinforced composite material may be continuous with (e.g. extend continuously into) the fibre-reinforced composite material surrounding the at least one region. The two or more sub-laminates of fibre-reinforced composite material may be continuous with (e.g. extend continuously into) a greater fibre-reinforced composite material laminate structure surrounding the at least one region.

The structural support casing may comprise one single region in which two or more sub-laminates of fibre-reinforced composite material are spaced apart from one another by ductile polymeric material.

The structural support casing may comprise two or more, for example, three or more, or four or more, or five or more, regions in which two or more sub-laminates of fibre-reinforced composite material are spaced apart from one another by ductile polymeric material. At least two (for example, each) of the two or more, for example, three or more, or four or more, or five or more, regions may be spaced apart from one another. At least two (for example, each) of the said regions may be spaced apart from one another around the circumference of the structural support casing. At least two (for example, each) of the said regions may be spaced apart from one another along the length of the structural support casing. At least two (for example, each) of the said regions may be spaced apart from one another along a radial direction, i.e. along the radial thickness of the structural support casing (e.g. proximate the two or more regions). The at least two (for example, each) of the said regions which are spaced apart from one another may be spaced apart from one another by fibre-reinforced composite material. The at least two (for example, each) of the said regions which are spaced apart from one another may be spaced apart from one another by joining regions of fibre-reinforced composite material. The fibre-reinforced composite material present in the at least two (for example, each) of the said regions which are spaced apart from one another may be continuous with the fibre-reinforced composite material in the joining regions. The two or more, for example, three or more, or four or more, or five or more, regions, in which two or more sub-laminates of fibre-reinforced composite material are spaced apart from one another by ductile polymeric material, may partially overlap one another. For example, the said regions may be spaced apart from one another along a radial direction but at least partially overlap around the circumference and/or along the length of the structural support casing.

It may be that the thickness (i.e. along the radial direction) of the ductile polymeric material, provided between each adjacent pair of sub-laminates of fibre-reinforced composite material, is no greater than the thickness (i.e. along the said radial direction) of any one of the two or more sub-laminates of fibre-reinforced composite material. For example, it may be that the maximum thickness (i.e. along the radial direction) of the one or more layers of ductile polymeric material is no greater than the thickness (i.e. along the said radial direction) of any one of the two or more sub-laminates of fibre-reinforced composite material. It may be that the thickness (i.e. along the radial direction) of (e.g. the one or more layers of) the ductile polymeric material is no greater than about 50% of the thickness (i.e. along the radial direction) of any one of the two or more sub-laminates of fibre-reinforced composite material.

It may be that the thickness of the ductile polymeric material (e.g. each of the one or more layers of ductile polymeric material) provided between each adjacent pair of the two or more sub-laminates of fibre-reinforced composite material is no greater than about 2.0 mm, for example, no greater than about 1.5 mm, or no greater than about 1.0 mm, or no greater than about 0.8 mm, or no greater than about 0.6 mm, or no greater than about 0.4 mm, or no greater than about 0.3 mm. It may be that the thickness of the ductile polymeric material (e.g. each of the one or more layers of ductile polymeric material) provided between each adjacent pair of the two or more sub-laminates of fibre-reinforced composite material is from about 0.05 mm to about 1.00 mm. It may be that the thickness of the ductile polymeric material (e.g. each of the one or more layers of ductile polymeric material) provided between each adjacent pair of the two or more sub-laminates of fibre-reinforced composite material is from about 0.1 mm to about 0.5 mm. It may be that the thickness of the ductile polymeric material (e.g. each of the one or more layers of ductile polymeric material) provided between each adjacent pair of the two or more sub-laminates of fibre-reinforced composite material is about 0.6 mm.

It may be that each sub-laminate of fibre-reinforced composite material comprises reinforcing fibre plies having a thickness of no greater than about 15 mm, for example, no greater than about 10.0 mm, or no greater than about 8.0 mm, or no greater than about 6.0 mm, or no greater than about 4.0 mm, or no greater than 1.0 mm, or no greater than about 0.8 mm, or no greater than about 0.6 mm, or no greater than about 0.4 mm, or no greater than about 0.3 mm.

It may be that each sub-laminate of fibre-reinforced composite material comprises at least two, for example, at least three, or at least four, or at least five, reinforcing fibre plies. It may be that each sub-laminate of fibre-reinforced composite material has a thickness of no less than about 0.6 mm, for example, no less than about 0.8 mm, or no less than about 1.0 mm, or no less than about 1.2 mm, or no less than about 1.4 mm, or no less than about 1.6 mm, or no less than about 1.8 mm, or no less than about 2.0 mm. It may be that each sub-laminate of fibre-reinforced composite material has a thickness of no greater than about 15.0 mm, for example, no greater than about 10.0 mm, or no greater than about 8.0 mm, or no greater than about 6.0 mm, or no greater than about 4.0 mm.

Each layer of ductile polymeric material may be thinner than each sub-laminate of fibre-reinforced composite material. Each layer of ductile polymeric material may have a thickness of no greater than 80%, for example, no greater than 70%, or no greater than 60%, or no greater than 50%, or no greater than 40%, or no greater than 30%, or no greater than 20%, of the thickness of any of the sub-laminates of fibre-reinforced composite material.

It may be that the ductile polymeric material has a density of no greater than about 2 g/cm³, for example, no greater than about 1.8 g/cm³, or no greater than about 1.6 g/cm³. It may be that the ductile polymeric material has a density of from about 1.0 g/cm³ to about 2.0 g/cm³. It may be that the ductile polymeric material has a density of about 1.6 g/cm³.

The structural support casing may include, along an axial extent thereof, a forward portion, a middle portion and an aft portion. The forward portion and the aft portion may be thinner than the middle portion. Each of the forward portion and the aft portion may be reduced in thickness with distance away from the middle portion. The at least one region, in which two or more sub-laminates of fibre-reinforced composite material are spaced apart from one another by ductile polymeric material, may be located in the middle portion. The at least one region, in which two or more sub-laminates of fibre-reinforced composite material are spaced apart from one another by ductile polymeric material, may be selectively located in a portion of the structural support casing configured to surround the fan. The at least one region, in which two or more sub-laminates of fibre-reinforced composite material are spaced apart from one another by ductile polymeric material, may selectively be located in a projected path of a fan blade-off. The at least one region, in which two more sub-laminates of fibre-reinforced composite material are spaced apart from one another by ductile polymeric material, may be at least one impact region, i.e. at least one impact region most likely to be impacted by a fan blade during an FBO event. The at least one impact region may be a region 10 degrees forwards and aft of where the centre of gravity plane of the fan intersects the engine centreline.

It may be that one, for example, two, of the two or more sub-laminates of fibre-reinforced composite material forms a surface of the structural support casing, for example, an outboard surface or an inboard surface.

According to a second aspect, there is provided a gas turbine engine comprising the structural support casing according to the first aspect. The structural support casing may enclose (e.g. support) a fan liner, for example, a fan impact liner and/or an acoustic liner. The structural support casing may enclose a fan.

According to a third aspect, there is provided a method of laying up a preform for a structural support casing for fan blade containment in a gas turbine engine, the method comprising: applying a first fibre-reinforced composite sub-laminate to a tool; applying ductile polymeric material onto the first fibre-reinforced composite sub-laminate; and applying a second fibre-reinforced composite sub-laminate onto the ductile polymeric material.

The preform may be a preform for an entire structural support casing. The preform may be a preform for a portion of a structural support casing. The structural support casing may be a fan containment casing (e.g. a fan containment case), for example, a hardwall fan containment casing (e.g. a hardwall fan containment case). The preform may be an uncured preform. The first and second fibre-reinforced composite sub-laminates may both be uncured fibre-reinforced composite sub-laminates. The tool may be a mandrel.

Applying the first fibre-reinforced composite sub-laminate to the tool may comprise (e.g. consist of) applying one or more, for example, two or more, or three or more, or four or more, reinforcing fibre plies to the tool. Applying the first fibre-reinforced composite sub-laminate to the tool may comprise (e.g. consist of) stacking the one or more, for example, two or more, or three or more, or four or more, reinforcing fibre plies on top of one another on the tool. The one or more, for example, two or more, or three or more, or four or more, reinforcing fibre plies may be applied individually to the tool. Alternatively, multiple (e.g., two or more, three or more, or four or more) reinforcing fibre plies may be applied to the tool together (i.e. at the same time). The one or more, for example, two or more, or three or more, or four or more, reinforcing fibre plies may be impregnated with uncured matrix material and/or one or more precursors to matrix material, i.e. said reinforcing fibre plies may be “pre-preg” reinforcing fibre plies. The one or more, for example, two or more, or three or more, or four or more, reinforcing fibre plies may be provided in the form of reinforcing fibre tape. The reinforcing fibre tape may be impregnated with uncured matrix material and/or one or more precursors to matrix material, i.e. said reinforcing fibre tape may be a “pre-preg” reinforcing fibre tape. Alternatively, matrix material may be injected into the preform after the reinforcing fibre plies have been applied.

Applying ductile polymeric material onto the first fibre-reinforced composite sub-laminate may comprise applying ductile polymeric material sheet onto the first fibre-reinforced composite sub-laminate. Alternatively, applying ductile polymeric material onto the first fibre-reinforced composite sub-laminate may comprise applying ductile polymeric material tape onto the first fibre-reinforced composite sub-laminate. Alternatively, applying ductile polymeric material onto the first fibre-reinforced composite sub-laminate may comprise spraying a film of the ductile polymeric material onto the first fibre-reinforced composite sub-laminate.

Applying the second fibre-reinforced composite sub-laminate onto the ductile polymeric material may comprise (e.g. consist of) applying one or more, for example, two or more, or three or more, or four or more, reinforcing fibre plies onto the ductile polymeric material. Applying the second fibre-reinforced composite sub-laminate onto the ductile polymeric material may comprise (e.g. consist of) stacking the one or more, for example, two or more, or three or more, or four or more, reinforcing fibre plies on top of one another on the ductile polymeric material. The one or more, for example, two or more, or three or more, or four or more, reinforcing fibre plies may be applied individually onto the ductile polymeric material. Alternatively, multiple (e.g., two or more, three or more, or four or more) reinforcing fibre plies may be applied onto the ductile polymeric material together (i.e. at the same time). The one or more, for example, two or more, or three or more, or four or more, reinforcing fibre plies may be impregnated with uncured matrix material and/or one or more precursors to matrix material, i.e. said reinforcing fibre plies may be “pre-preg” reinforcing fibre plies. The one or more, for example, two or more, or three or more, or four or more, reinforcing fibre plies may be provided in the form of reinforcing fibre tape. The reinforcing fibre tape may be impregnated with uncured matrix material and/or one or more precursors to matrix material, i.e. said reinforcing fibre tape may be a “pre-preg” reinforcing fibre tape. Alternatively, matrix material may be injected into the preform after the reinforcing fibre plies have been applied.

The steps of applying ductile polymeric material and applying fibre-reinforced composite sub-laminate may be repeated to build up a preform comprising three or more, for example, four or more, or five or more, sub-laminates of fibre-reinforced composite material spaced apart from one another by ductile polymeric material. For example, the method may comprise applying the first fibre-reinforced composite sub-laminate to the tool; applying the ductile polymeric material onto the first fibre-reinforced composite sub-laminate; applying the second fibre-reinforced composite sub-laminate onto the ductile polymeric material; applying ductile polymeric material onto the second fibre-reinforced composite sub-laminate; and applying a third fibre-reinforced composite sub-laminate onto the ductile polymeric material provided on the second fibre-reinforced composite sub-laminate.

The ductile polymeric material may consist of one polymer or it may comprise more than one polymer, e.g. it may be a blend of polymers. It may be that the ductile polymeric material comprises one or more additives or stabilisers, for example, selected from: plasticizers, reinforcing agents, fire retardants, antioxidants, anti-ozonants, acid scavengers, light-stabilisers (e.g. UV-absorbers). It may be that the ductile polymeric material comprises one or more fillers, for example, one or more mineral fillers. It may be that the ductile polymeric material comprises one or more polymers containing urethane (i.e. carbamate) groups, for example, polyurethane. It may be that the ductile polymeric material comprises one or more polymers formed on reaction of phenolic acid (i.e. phenol) or substituted phenolic acid (i.e. substituted phenol) with formaldehyde (i.e. methanal), for example, phenolic polymer or phenolic resin (otherwise known as phenol formaldehyde resin).

The fibre-reinforced composite material may be fibre-reinforced polymer, i.e. the (i.e. cured) matrix material of the fibre-reinforced composite material may be a polymer. The matrix material of the fibre-reinforced composite material may be a thermosetting polymer (i.e. a thermoset). The uncured matrix material may comprise one or more of the following: epoxy resin, polyester resin, polyimide resin, silicone resin, benzoxazine resin, bis-maleimide resin, cyanate ester resin, vinyl ester resin, phenolic resin, polyurethane resin. The uncured matrix material may comprise one or more catalysts or initiators. The cured matrix material may comprise one or more of the following: epoxy (i.e. cured epoxy resin), polyester, polyimide, polysiloxane, vinyl ester, polyamide, polyurethane, polybenzoxazine, bis-maleimide, cyanate ester.

The fibre-reinforced composite material may comprise carbon reinforcing fibres. The fibre-reinforced composite material may be carbon fibre reinforced polymer (CFRP). The fibre-reinforced composite material may comprise aramid (i.e. aromatic polyamide) reinforcing fibres. The fibre-reinforced composite material may comprise para-aramid reinforcing fibres. For example, the fibre-reinforced composite material may comprise reinforcing fibres formed from poly-paraphenylene terephthalamide (Kevlar®) or p-phenylene terephthalamide (Twaron®). The fibre-reinforced composite material may comprise reinforcing fibres formed from a thermoset liquid-crystalline polyoxazole. For example, the fibre-reinforced composite material may comprise reinforcing fibres formed from poly(p-phenylene-2,6-benzobisoxazole) (Zylon®).

According to a fourth aspect, there is provided a method of manufacturing a structural support casing for fan blade containment in a gas turbine engine, the method comprising: laying up a preform for the structural support casing by the method according to the third aspect; and curing the preform.

Curing the preform may comprise heating the preform. Curing the preform may comprise heating the preform to a temperature no greater than 300° C., for example, no greater than 250° C., or no greater than 200° C., or no greater than 180° C. Curing the preform may comprise heating the preform to a temperature no less than 100° C., for example, a temperature no less than 150° C.

Additionally or alternatively, curing the preform may comprise applying pressure to the preform.

The method may further comprise forming or shaping the preform prior to curing and/or forming or shaping the structural support casing after curing.

According to a fifth aspect, there is provided a carbon fibre reinforced polymer (CFRP) composite structural support casing for fan blade containment in a gas turbine engine, the CFRP composite structural support casing comprising at least one region in which two or more CFRP sub-laminates are spaced apart from one another by polyurethane and/or phenolic resin having an elongation to failure of at least about 50%, for example, at least about 100%, and/or a tensile modulus no greater than about 10 GPa, for example, no greater than about 5 GPa. The thickness of the polyurethane and/or phenolic resin provided between each adjacent pair of the two or more CFRP sub-laminates may be no greater than about 2.0 mm, for example, no greater than about 1.0 mm.

According to a sixth aspect, there is provided a carbon fibre reinforced polymer (CFRP) composite structural support casing for fan blade containment in a gas turbine engine, the CFRP composite structural support casing comprising at least one region in which two or more CFRP sub-laminates are spaced apart from one another by polyurea and/or toughened adhesives and/or a polymer matrix comprising thermoplastic particles, glass microspheres or polymer microspheres, having a toughness of at least about 1 MPa/m³, for example at least about 5 MPa/m³, and/or a tensile modulus no greater than about 5 GPa, for example no greater than about 1 GPa. The thickness of the polyurea and/or toughened adhesives and/or a polymer matrix comprising thermoplastic particles, glass microspheres or polymer microspheres provided between each adjacent pair of the two or more CFRP sub-laminates may be no greater than about 1 mm, for example, no greater than about 0.5 mm.

The skilled person will appreciate that, except where mutually exclusive, a feature described in relation to any one of the above aspects may be applied mutatis mutandis to any other aspect. Furthermore, except where mutually exclusive, any feature described herein may be applied to any aspect and/or combined with any other feature described herein.

### FIGURES

Embodiments will now be described by way of example only, with reference to the Figures, in which:

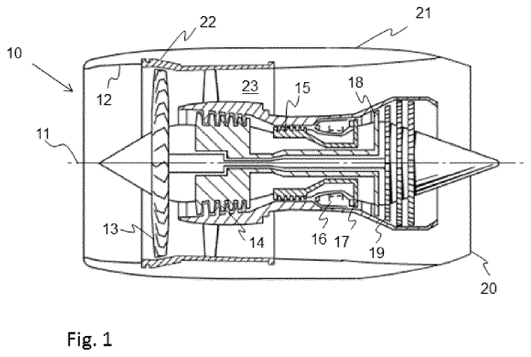

a. FIG. 1 is a sectional side view of a gas turbine engine;

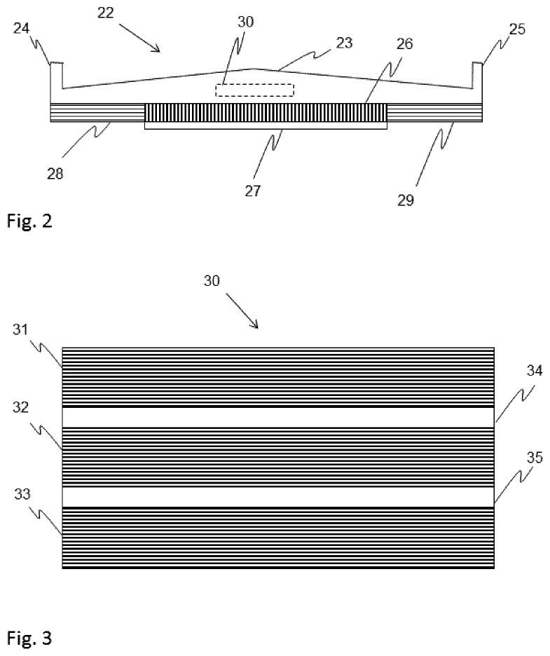

b. FIG. 2 is a sectional side view of a fan containment case;

c. FIG. 3 is a schematic sectional view through a portion of a fan containment case;

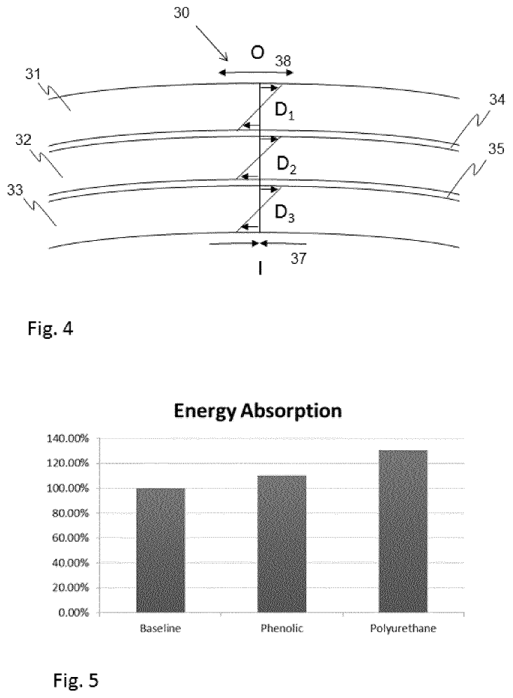

d. FIG. 4 is a diagrammatic representation of shear force distribution through a portion of a fan containment case;

e. FIG. 5 is a plot of energy absorbed on impact of a fan blade for three example materials;

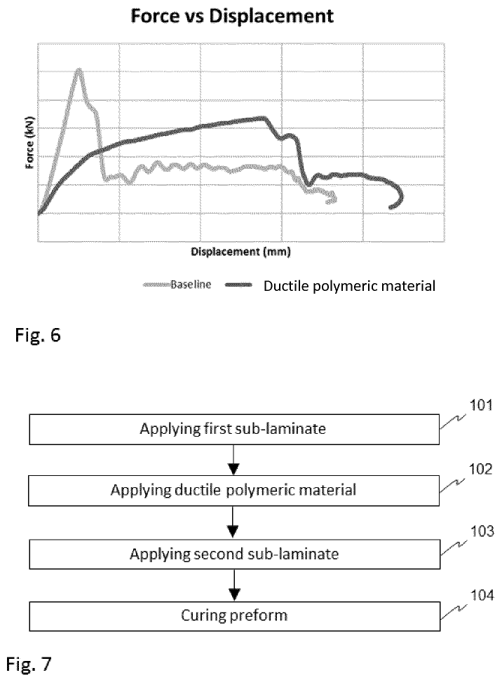

f. FIG. 6 is a force-displacement plot for carbon-fibre and ductile polymer composite materials; and

g. FIG. 7 is a flow diagram of a method of manufacturing a fan containment case.

### DETAILED DESCRIPTION

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20. A fan containment case 22 extends around the fan 13 inboard the nacelle 21.

The gas turbine engine 10 works in the conventional manner so that air entering the intake 12 is accelerated by the fan 13 to produce two air flows: a first air flow into the intermediate pressure compressor 14 and a second air flow which passes through a bypass duct 23 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The structure of the fan containment case 22 is illustrated in more detail in FIG. 2 which shows a sectional view of one portion of the fan containment case. The fan containment case 22 comprises a middle portion (a barrel) 23 which extends between a forward portion 24 and an aft portion 25. The fan containment case 22 is formed predominantly from fibre-reinforced composite material and is located around the fan 13.

A fan impact liner 26 is adhered to an inboard surface of the middle portion 23 of the fan containment case 22. The fan impact liner 26 is constructed from layers of fibre-reinforced composite material and honeycomb material and is designed to absorb a substantial amount of energy on impact of a blade during a fan blade-off (FBO) event. An abradable layer 27 constructed from honeycomb material is adhered to the fan impact liner 26. Forward and aft acoustic liners 28 and 29 are adhered to the fan containment case 22 proximate the forward 24 and aft 25 portions respectively. The fan containment case 22 acts as a rigid structural support for the fan impact liner 26, abradable layer 27, and acoustic liners 28 and 29.

The internal structure of an impact portion 30 of the middle portion 23 of the fan containment case 22 is shown in more detail in FIG. 3. This portion 30 of the fan containment case 22 is formed from alternating sub-laminate layers of carbon-fibre reinforced polymer (CFRP) material 31, 32 and 33 spaced apart from one another by layers of a ductile polymeric material 34 and 35, for example, polyurethane or phenolic resin. The layers of ductile polymeric material 34 and 35 are bonded directly to the CFRP sub-laminates to provide a laminate structure. The layers of ductile polymeric material are typically substantially thinner than the CFRP sub-laminates. For example, the layers of ductile polymeric material may be about 0.5 mm thick while each CFRP sub-laminate may be about 3.0 mm thick. The CFRP material comprises unidirectional carbon fibre plies bonded to one another in a resin matrix, although it will be appreciated that the CFRP material could be replaced by any fibre-reinforced composite material the skilled person considers suitable for use. The ductile polymeric layers are solid polymer films.

The impact portion 30 extends angularly completely around the engine (i.e. completely around the circumference of the fan containment case 22) in the region of the fan containment case 22 which is proximate the fan. The remainder of the fan containment case 22 may be formed from CFRP material without layers of ductile polymeric material, although the structure of the impact portion 30 may also be repeated in other regions, for example, throughout the fan containment case.

The structure of the impact portion 30 is designed to absorb a significant amount of energy from an impacting fan blade during an FBO event. In particular, ductile polymeric materials, like polyurethane or phenolic resins, are significantly more ductile and flexible than fibre-reinforced materials like CFRP. For example, ductile polymeric materials like polyurethane or phenolic resins typically have significantly higher elongations to failure and significantly lower elastic moduli (in particular, tensile elastic moduli) than fibre-reinforced materials like CFRP. Accordingly, on impact of a fan blade during an FBO event, the layers of ductile polymeric material in the impact portion of the fan containment case are able to undergo substantially more elastic and plastic deformation compared to the sub-laminates of CFRP. This means that, on impact, the ductile polymeric layers effectively behave independently of the CFRP sub-laminates and shear stress transfer between adjacent ductile polymeric layers and CFRP sub-laminates is minimal.

This effect is illustrated in FIG. 4 which shows that an impact occurring on an inboard surface at point I leads to shear stress distributions shown schematically at D1, D2 and D3 for sub-laminates 31, 32 and 33 and minimal stress supported by the ductile polymeric layers 34 and 35. The resultant compressive stress experienced by the CRFP sub-laminate 33 on the inboard side of the impact portion (indicated by arrows 37 at point I) and the tensile stress experienced by the CFRP sub-laminate 31 on the outboard side of the impact portion (indicated by arrows 38 at point O) is much reduced compared to the compressive and tensile stresses which would be experienced were the ductile polymeric layers not present. This reduces the likelihood that the ultimate tensile or compressive strengths of the carbon fibres in the CFRP sub-laminates will be reached and, consequently, reduces the likelihood of brittle failure of the CFRP sub-laminates.

By including the layers of ductile polymeric material, the CFRP sub-laminates are able to bend more before failure than could be achieved using a monolithic slab of CFRP material. Effectively, the ductility of the CFRP laminate structure is increased by inclusion of the layers of ductile polymeric material. The impact region of the fan containment case is therefore able to absorb significantly more energy on impact of a fan blade. In addition, crack propagation through the thickness of the laminate structure is hindered by the presence of the ductile polymeric material layers which deform first elastically and then plastically on impact rather than undergoing brittle failure.

FIG. 5 compares the amount of energy which can be absorbed by a test portion of a fan containment case comprising an impact region containing ductile polymeric layers with the baseline amount of energy absorbed by a reference test portion of a pure CFRP fan containment case under the same impact conditions. In FIG. 5, the amounts of energy absorbed by phenolic and polyurethane layers are expressed as percentages relative to a normalised baseline of 100%. Use of both phenolic resins and polyurethane layers leads to an increase in the amount of energy absorbed. The ductile polymeric layers increase the amount of energy required to initiate a crack through the laminate structure or to initiate fibre failure (referred to as the “initiation energy”), both of which mechanisms can result in a reduction in load carrying capacity. Of these two examples, use of polyurethane in particular, which has a higher elongation to failure, leads to a substantial increase in the total amount of energy absorbed on impact.

FIG. 6 shows force-displacement plots measured for CFRP sub-laminates spaced apart by a polyurethane ductile polymeric material (dark grey) and for a CFRP laminate structure lacking ductile polymeric material (light grey). The ductility of the laminate is increased significantly by addition of the ductile polymeric layers, as indicated by the increased maximum displacement before yield. The energy absorbed by the structures can be determined by the area under the force-displacement plots.

The fan containment case 22 may be manufactured using standard composite manufacturing techniques well-known in the field. For example, fan containment case 22 may be manufactured by first laying up a preform for the fan containment case and subsequently curing the preform. Laying up the preform typically involves repeatedly applying carbon-fibre plies to a shaped tool such as a mandrel in a layer-wise manner. Carbon-fibre plies may be applied in the form of carbon-fibre tapes, particularly carbon-fibre tapes pre-impregnated with uncured matrix material such as an uncured resin. Alternatively, uncured matrix material may be injected into the preform after laying up has been completed.

The impact region of the preform may be constructed by, in the impact region, applying a sheet of the chosen ductile polymeric material instead of individual carbon-fibre plies. The ductile polymeric material may also be provided in the form of a polymer tape so that the same automated lay-up tools may be used to lay up both carbon-fibre and polymer materials. For example, in the impact region, every fifth carbon-fibre ply may be replaced by a sheet of the ductile polymeric material.

The preform may be shaped or formed prior to curing using any composite shaping or forming techniques known in the art, for example, to form the shaped forward and aft portions of the fan containment case.

After laying-up and/or shaping or forming is completed, the preform is cured, typically by heating to the curing temperature of the matrix material and/or applying pressure to the preform.

A simplified method of manufacturing the fan containment case is illustrated in a flow diagram in FIG. 7. In block 101, a first carbon fibre ply impregnated with matrix material is applied to a tool to form a first sub-laminate. In block 102, ductile polymeric material is applied onto the first sub-laminate. In block 103, a second carbon fibre ply impregnated with matrix material is applied to the ductile polymeric material to form a second sub-laminate, thereby forming a preform for the fan containment case. In block 104, the preform structure is cured, for example, by application of heat and pressure.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A hardwall fan containment casing for fan blade containment in a gas turbine engine, the hardwall fan containment casing comprising at least one region in which two or more sub-laminates of fibre-reinforced composite material are spaced apart from one another by ductile polymeric material.

2. The hardwall fan containment casing according to claim 1, wherein a tensile modulus of the ductile polymeric material is no greater than about 50% of a tensile modulus of the fibre-reinforced composite material.

3. The hardwall fan containment casing according to claim 1, wherein a tensile modulus of the ductile polymeric material is no greater than about 10 GPa.

4. The hardwall fan containment casing according to claim 1, wherein an elongation to failure of the ductile polymeric material is at least five times, for example, at least ten times, the an elongation to failure of the fibre-reinforced composite material.

5. The hardwall fan containment casing according to any claim 1, wherein an elongation to failure of the ductile polymeric material is at least about 50%.

6. The hardwall fan containment casing according to claim 5, wherein an elongation to failure of the fibre-reinforced composite material (31, 32, 33) is no greater than about 10%.

7. The hardwall fan containment casing according to claim 1, wherein the fibre-reinforced composite material has a tensile strength of at least about 1000 MPa and the ductile polymeric material has a tensile strength of no greater than about 200 MPa.

8. The hardwall fan containment casing according to any preceding claim 1, wherein the ductile polymeric material is not susceptible to thermal degradation at or below a temperature of 200° C.

9. The hardwall fan containment casing according to claim 1, wherein the ductile polymeric material comprises polyurethane and/or phenolic resin and the fibre-reinforced composite material is a fibre-reinforced polymer.

10. The hardwall fan containment casing according to claim 1, wherein the two or more sub-laminates of fibre-reinforced composite material are spaced apart from one another by one or more solid layers of unreinforced, ductile polymeric material.

11. The hardwall fan containment casing according to claim 1, wherein a thickness of the ductile polymeric material provided between each of one or more adjacent pairs of sub-laminates of fibre-reinforced composite material, is no greater than a thickness of any one of the two or more sub-laminates of fibre-reinforced composite material of the pair.

12. The hardwall fan containment casing according to claim 1, wherein the at least one region, in which the two or more sub-laminates of fibre-reinforced composite material are spaced apart from another by the ductile polymeric material, extends around a majority of a circumference of the structural support casing.

13. (canceled)

14. A method of laying up a preform for a hardwall fan containment casing for fan blade containment in a gas turbine engine, the method comprising:
applying a first fibre-reinforced composite sub-laminate to a tool; applying ductile polymeric material onto the first fibre-reinforced composite sub-laminate; and applying a second fibre-reinforced composite sub-laminate onto the ductile polymeric material.

15. The method according to claim 14, further comprising curing the preform to provide the hardwall fan containment casing for fan blade containment in a gas turbine engine.

16. The method according to claim 14, wherein the ductile polymeric material which spaces apart the two or more sub-laminates is a thermoplastic polymer.

17. The hardwall fan containment casing according to claim 1, wherein the ductile polymeric material which spaces apart the two or more sub-laminates is a thermoplastic polymer.

18. The hardwall fan containment casing according to claim 11, wherein the thickness of ductile polymeric material, provided between each adjacent pair of sub-laminates of fibre-reinforced composite material, is no greater than about 50% of the thickness of any one of the two or more sub-laminates of fibre-reinforced composite material of the pair.

19. A hardwall fan containment casing for fan blade containment in a gas turbine engine, the hardwall fan containment casing comprising at least one region in which two or more sub-laminates of fibre-reinforced composite material are spaced apart from one another by ductile polymeric material;
wherein a tensile modulus of the ductile polymeric material is no greater than about 50% of a tensile modulus of the fibre-reinforced composite material; and
wherein an elongation to failure of the ductile polymeric material is at least five times an elongation to failure of the fibre-reinforced composite material.

20. The hardwall fan containment casing according to claim 19, wherein the tensile modulus of the ductile polymeric material is no greater than about 25% of the tensile modulus of the fibre-reinforced composite material.

21. The hardwall fan containment casing according to claim 19, wherein the elongation to failure of the ductile polymeric material is at least ten times the elongation to failure of the fibre-reinforced composite material.
